(19) United States
(12) Patent Application Publication
(10) Pub. No.: US 2008/0204615 A1
(43) Pub. Date: Aug. 28, 2008

(54) LIQUID CRYSTAL DISPLAY AND METHOD THEREOF

(75) Inventors: Kyoung-Ju Shin, Hwaseong-si (KR); Jin-Ho Ju, Seoul (KR); Chong-Chul Chai, Seoul (KR)

Correspondence Address: CANTOR COLBURN, LLP, 20 Church Street, 22nd Floor, Hartford, CT, 06103, US

(73) Assignee: Samsung Electronics Co., Ltd., Suwon-si (KR)

(21) Appl. No.: 12/033,188

(22) Filed: Feb. 19, 2008

(30) Foreign Application Priority Data
Feb. 26, 2007 (KR) 10-2007-0019018

(51) Int. Cl. G02F 1/1333; G02F 1/1368; G02F 1/13

(52) U.S. Cl. 349/38; 349/48

(57) ABSTRACT

A liquid crystal display (“LCD”) includes a gate line, a data line intersecting the gate line, a pixel including first and second sub-pixels connected to the gate line and the data line, and a coupling capacitor coupled between the first and the second sub-pixels. The first sub-pixel includes a first liquid crystal (“LC”) capacitor and a first thin film transistor (“TFT”). The second sub-pixel includes a second LC capacitor and a second TFT. The first and second TFTs respectively include a gate electrode, a source electrode, and a drain electrode. The gate electrodes of the first and second TFTs are connected to the gate line, the source electrodes of the first and second TFTs are connected to the data line, and the coupling capacitor includes the sub-pixel electrode of the second sub-pixel and the drain electrode of the second TFT as two terminals.

This application claims priority to Korean Patent Application No. 10-2007-0019018, filed on Feb. 26, 2007, and all the benefits accruing therefrom under 35 U.S.C. §119, the contents of which in its entirety are herein incorporated by reference.

### BACKGROUND OF THE INVENTION

(a) Field of the Invention

The present invention relates to a liquid crystal display (“LCD”) and method thereof. More particularly, the present invention relates to an LCD preventing generation of an image-retension and improving lateral visibility, and a method thereof.

(b) Description of the Related Art

Liquid crystal displays (“LCDs”) are one of the most widely used type of flat panel displays, and an LCD includes a pair of panels provided with field-generating electrodes, such as pixel electrodes and a common electrode, and a liquid crystal (“LC”) layer interposed between the two panels. The LCD displays images by applying voltages to the field-generating electrodes to generate an electric field in the LC layer that determines the orientations of LC molecules therein to adjust polarization of incident light.

An LCD also includes switching elements connected to the respective pixel electrodes, and a plurality of signal lines, such as gate lines and data lines, for controlling the switching elements and thereby applying voltages to the pixel electrodes.

Among the LCDs, a vertical alignment (“VA”) mode LCD, which aligns LC molecules such that the long axes of the LC molecules are perpendicular to the panels in the absence of an electric field, has a high contrast ratio and wide reference viewing angle.

A wide reference viewing angle is defined as a viewing angle that makes the contrast ratio equal to 1:10, or as a limit angle for the inversion in luminance between the grays.

The wide viewing angle of the VA mode LCD can be realized by cutouts in the field-generating electrodes and protrusions on the field-generating electrodes.

Since the cutouts and the protrusions can determine the tilt directions of the LC molecules in the LC layer, the tilt directions can be distributed in several directions by using the cutouts and the protrusions such that the reference viewing angle is widened.

However, the cutouts and protrusions may cause a decrease of the aperture ratio.

To increase the aperture ratio, a high aperture ratio maximizing the size of the pixel electrode is provided. In this case, because the intervals between the pixel electrodes become close, a strong lateral field is formed between the pixel electrodes.

The arrangements of the LC molecules are scattered due to this lateral field such that a texture or light leakage is generated.

Also, the VA mode LCD has poor lateral visibility as compared with front visibility.

For example, the image becomes brighter closer to the lateral field in the case of the liquid crystal display of a patterned vertically aligned (“PVA”) mode, and the differences between the luminance of the high grays disappear in the serious case such that mashed images (spots) may appear on the screen.

To improve the lateral visibility of the VA mode LCD, a VA mode LC that displays while dividing one pixel into two sub-pixels and applying different voltages to the sub-pixels for different transmittances is provided. One sub-pixel is directly applied with a higher voltage and the other is coupled to the sub-pixel through a coupling capacitor so that a lower voltage is applied thereto.

### BRIEF SUMMARY OF THE INVENTION

The present invention provides a liquid crystal display (“LCD”) to prevent the generation of an image-retension as well as to improve lateral visibility.

An LCD according to exemplary embodiments of the present invention includes a gate line, a data line intersecting the gate line, a pixel including first and second sub-pixels connected to the gate line and the data line, and a coupling capacitor coupled between the first and second sub-pixels. The first sub-pixel includes a first LC capacitor, a first storage capacitor, and a first thin film transistor (“TFT”). The second sub-pixel includes a second LC capacitor, a second storage capacitor, and a second TFT. The first and second TFTs respectively include a gate electrode, a source electrode, and a drain electrode. The gate electrodes of the first and second TFTs are connected to the gate line. The source electrodes of the first and the second TFT are connected to the data line. The coupling capacitor includes the sub-pixel electrode of the second sub-pixel and the drain electrode of the second TFT as two terminals.

The gate electrodes of the first and second TFTs may be connected to each other. The source electrodes of the first and second TFTs may be connected to each other.

The drain electrode of the first TFT may be connected to the sub-pixel electrode of the first sub-pixel.

A storage electrode overlapping the sub-pixel electrodes of the first and second sub-pixels may be included. The first storage capacitor may include the sub-pixel electrode of the first sub-pixel and the storage electrode as two terminals, and the second storage capacitor may include the sub-pixel electrode of the second sub-pixel and the storage electrode as two terminals.

The first LC capacitor may include a first sub-pixel electrode, and the second LC capacitor may include a second sub-pixel electrode that is capacitively coupled with the first sub-pixel electrode.

A voltage of the first sub-pixel may be different from a voltage of the second sub-pixel. The voltage of the first sub-pixel may be higher than of the voltage of the second sub-pixel.

An area of the first sub-pixel electrode may be different from an area of the second sub-pixel electrode.

A common electrode opposite the first and second sub-pixel electrodes may be included, wherein the first and second LC capacitors include the common electrode as one terminal.

An LCD according to other exemplary embodiments of the present invention includes a pixel electrode including a first sub-pixel electrode and a second sub-pixel electrode separated from the first sub-pixel electrode, a first TFT connected to the first sub-pixel electrode, a second TFT connected to the second sub-pixel electrode, a storage electrode overlapping the first and second sub-pixel electrodes, and a coupling electrode overlapping the second sub-pixel electrode, wherein the second TFT includes a drain electrode and the coupling electrode is connected to the drain electrode of the second TFT.

A first signal line connected to the first and second TFTs, and a second signal line connected to the first and second TFTs and intersecting the first signal line may be included.

According to still other exemplary embodiments of the present invention, a method of reducing generation of an image-retension in an LCD, the LCD including a pixel having a first sub-pixel and a second sub-pixel, includes applying first and second sub-pixel electrode voltages to the first and second sub-pixels via a same data line, the second sub-pixel electrode voltage being less than the first sub-pixel electrode voltage, applying a gate off voltage to first and second liquid crystal capacitors of the first and second sub pixels via a same gate line, and substantially equalizing an amount of first and second kickback voltages of the first and second sub-pixels.

### BRIEF DESCRIPTION OF THE DRAWINGS

The above and other aspects, features and advantages of the present invention will become more readily apparent by describing in further detail exemplary embodiments thereof with reference to the accompanying drawings, in which:

FIG. 1 is a block diagram of an exemplary LCD according to an exemplary embodiment of the present invention;

FIG. 2 is an equivalent circuit diagram of two exemplary sub-pixels of an exemplary LCD according to an exemplary embodiment of the present invention;

FIG. 3 is an equivalent circuit diagram of an exemplary pixel of the exemplary LC panel assembly according to an exemplary embodiment of the present invention;

FIG. 4 is a layout view of an exemplary lower panel for an exemplary LCD according to an exemplary embodiment of the present invention;

FIG. 5 is a layout view of an exemplary upper panel for an exemplary LCD according to an exemplary embodiment of the present invention;

FIG. 6 is a layout view of an exemplary LC panel assembly including the exemplary lower panel shown in FIG. 4 and the exemplary upper panel shown in FIG. 5;

FIG. 7 and FIG. 8 are cross-sectional views of the exemplary LC panel assembly shown in FIG. 6 taken along lines VII-VII′ and VIII-VIII′, respectively; and,

FIG. 9 is a waveform showing pixel electrode voltages of the exemplary LCD according to an exemplary embodiment of the present invention.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. In the drawings, the thickness of layers, films, panels, regions, etc., are exaggerated for clarity. Like reference numerals designate like elements throughout the specification.

It will be understood that when an element such as a layer, film, region, or substrate is referred to as being “on” another element, it can be directly on the other element or intervening elements may also be present. In contrast, when an element is referred to as being “directly on” another element, there are no intervening elements present. As used herein, the term “and/or” includes any and all combinations of one or more of the associated listed items.

It will be understood that although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof.

Furthermore, relative terms, such as “lower” or “bottom” and “upper” or “top” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on the “upper” side of the other elements. The exemplary term “lower” can, therefore, encompass both an orientation of “lower” and “upper,” depending upon the particular orientation of the figure. Similarly, if the device in one of the figures were turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning which is consistent with their meaning in the context of the relevant art and the present disclosure, and will not be interpreted in an idealized or overly formal sense unless expressly so defined herein.

Exemplary embodiments of the present invention are described herein with reference to cross section illustrations which are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes which result, for example, from manufacturing. For example, a region illustrated or described as flat may, typically, have rough and/or nonlinear features. Moreover, sharp angles which are illustrated may be rounded. Thus, the regions illustrated in the figures are schematic in nature and their shapes are not intended to illustrate the precise shape of a region and are not intended to limit the scope of the present invention.

Hereinafter, the exemplary embodiments of the present invention will be explained in further detail with reference to the accompanying drawings.

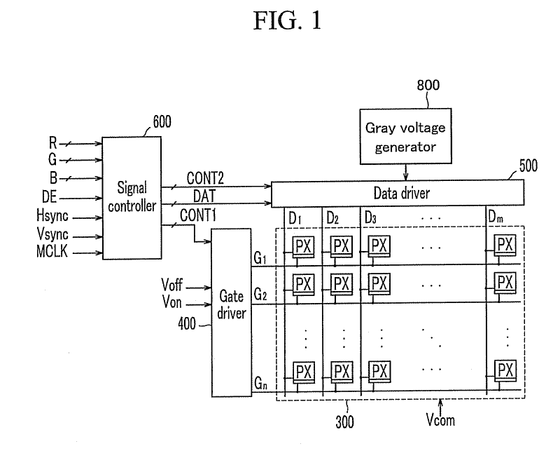

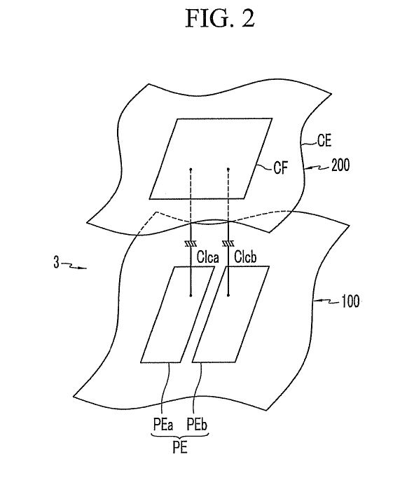

FIG. 1 is a block diagram of an exemplary LCD according to an exemplary embodiment of the present invention, and FIG. 2 is an equivalent circuit diagram of two exemplary sub-pixels of an exemplary LCD according to an exemplary embodiment of the present invention.

As shown in FIG. 1, an LCD according to an exemplary embodiment of the present invention includes an LC panel assembly 300, a gate driver 400 and a data driver 500 that are connected to the LC panel assembly 300, a gray voltage generator 800 connected to the data driver 500, and a signal controller 600 for controlling the above elements.

The LC panel assembly 300 includes a plurality of signal lines, such as gate lines G1 to Gn and data lines D1 to Dm, and a plurality of pixels PX connected to the signal lines and arranged substantially in a matrix, as seen in the equivalent circuit diagram.

The LC panel assembly 300 further includes lower and upper panels 100 and 200 that face each other and an LC layer 3 interposed therebetween, as in the structural view shown in FIG. 2.

The signal lines include the plurality of gate lines G1 to Gn for transmitting gate signals (also referred to as “scanning signals”) and the plurality of data lines D1 to Dm for transmitting data signals.

The gate lines G1 to Gn extend substantially in a row direction, a first direction, and substantially parallel to each other, and the data lines D1 to Dm extend substantially in a column direction, a second direction substantially perpendicular to the first direction, and substantially parallel to each other.

Each pixel PX includes a pair of sub-pixels PXa and PXb, and the sub-pixels PXa and PXb respectively include LC capacitors Clca and Clcb.

At least one of the two sub-pixels PXa, PXb includes a switching element connected to the gate line GL, the data line DL, and the liquid crystal capacitors Clca and/or Clcb.

The LC capacitor Clca/Clcb includes a sub-pixel electrode PEa/PEb provided on the lower panel 100 and a common electrode CE provided on an upper panel 200 as two terminals, and the LC layer 3 disposed between the sub-pixel electrode PEa/PEb and the common electrode CE functions as a dielectric of the LC capacitor Clca/Clcb.

Each of the pair of sub-pixel electrodes PEa and PEb are separated from each other and together form a pixel electrode PE.

The common electrode CE is formed on the entire surface, or at least substantially the entire surface, of the upper panel 200 and is supplied with a common voltage Vcom.

The LC layer 3 has negative dielectric anisotropy, and the LC molecules in the LC layer 3 may be aligned such that their major axes are substantially perpendicular to the two panels 100, 200 in the absence of an electric field.

Alternatively, unlike FIG. 2, the common electrode CE may be provided on the lower panel 100, and in this case, at least one of the two electrodes PE and CE may have a shape of a stripe or bar.

In order to implement color display, each pixel PX uniquely displays one color in a set of colors (spatial division), such as primary colors, or each pixel PX sequentially displays the set of colors in turn (temporal division) such that the spatial or temporal sum of the colors is recognized as a desired color.

An example of a set of colors may include primary colors, and may include red, green, and blue.

FIG. 2 shows an example of spatial division in which each pixel PX includes a color filter CF representing one of the colors in the set of colors in an area of the upper panel 200 facing the pixel electrode PE.

Alternatively, unlike FIG. 2, the color filter CF may be provided on or under the pixel electrode PE provided on the lower panel 100.

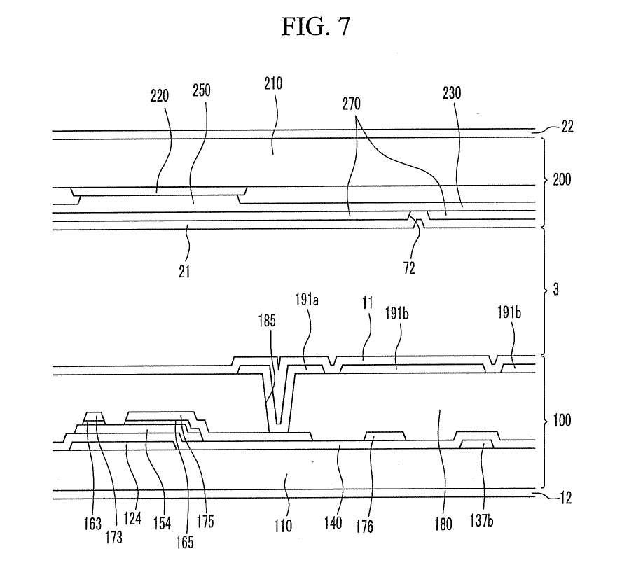

Polarizers (as will be further shown and described with respect to FIG. 7) are provided on the outer surface of the panels 100 and 200, and the polarization axes of the two polarizers may be perpendicular to each other.

Referring to FIG. 1 again, the gray voltage generator 800 generates two sets of a plurality of gray voltages (or reference gray voltages) related to the transmittance of the pixels PX. However, the gray voltage generator 800 may generate only a given number of gray voltages (referred to as reference gray voltages) instead of generating all of the gray voltages.

Gray voltages of one set have a positive value with respect to the common voltage Vcom, while gray voltages of the other set have a negative value with respect to the common voltage Vcom.

The gate driver 400 is connected to the gate lines G1 to Gn of the LC panel assembly 300, and synthesizes a gate-on voltage Von and a gate-off voltage Voff to generate gate signals Vg, which are applied to the gate lines G1 to Gn.

The data driver 500 is connected to the data lines D1 to Dm of the LC panel assembly 300, and selects the gray voltages supplied from the gray voltage generator 800 and then applies a selected gray voltage to the data lines D1 to Dm as a data signal.

However, in the case where the gray voltage generator 800 does not provide voltages for all the grayscale but provides only a predetermined number of reference grayscale voltages, the data driver 500 divides the reference grayscale voltages to generate gray voltages for all the grayscales and selects a data signal from the generated gray voltages.

The signal controller 600 controls the gate driver 400 and the data driver 500.

Each of the drivers 400, 500, 600, and 800 mentioned above may be directly mounted on the LC panel assembly 300 in the form of at least one integrated circuit (“IC”) chip, may be mounted on a flexible printed circuit film (not shown) in a tape carrier package (“TCP”) type that is attached to the LC panel assembly 300, or may be mounted on a separate printed circuit board (“PCB”) (not shown).

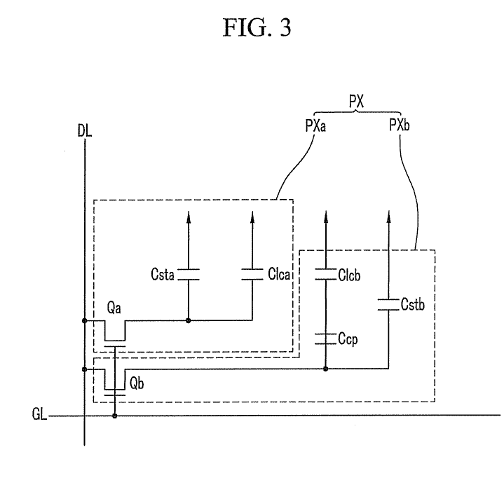

Alternatively, each of the drivers 400, 500, 600, and 800 may be integrated along with the signal lines G1-Gn and D1-Dm, and thin film transistor (“TFT”) switching elements, such as Qa and Qb as shown in FIG. 3, on the LC panel assembly 300.

Also, the drivers 400, 500, 600, and 800 may be integrated into a single chip, and in this case, at least one thereof or at least one circuit element forming them may be located outside of the single chip.

Now, a structure of the LC panel assembly 300 will be described in detail with reference to FIG. 3 to FIG. 8 along with FIG. 1 and FIG. 2 described above.

FIG. 3 is an equivalent circuit diagram of an exemplary pixel of an exemplary LC panel assembly according to an exemplary embodiment of the present invention.

Referring to FIG. 3, an LC panel assembly according to the present embodiment includes signal lines including a plurality of gate lines GL, a plurality of data lines DL, and a plurality of pixels PX connected to the signal lines GL and DL.

Each pixel PX includes a pair of sub-pixels PXa and PXb.

The first sub-pixel PXa includes a first switching element Qa connected to the corresponding gate line GL and data line DL, and a first LC capacitor Clca and a first storage capacitor Csta connected to the first switching element Qa, while the second sub-pixel PXb includes a second switching element Qb connected to the corresponding gate line GL, and the data line DL, and a second LC capacitor Clcb, a second storage capacitor Cstb connected to the second switching element Qb, and a coupling capacitor Ccp.

Each switching element Qa/Qb including a TFT is a three-terminal element provided on the lower panel 100.

The control terminals, or gate electrodes, of the first and second switching elements Qa and Qb are connected to the same gate line GL, and the input terminals, or source electrodes, thereof are also connected to the same data line DL.

The output terminal, or drain electrode, of the first switching element Qa is connected to the first LC capacitor Clca and the first storage capacitor Csta.

The output terminal, or drain electrode, of the second switching element Qb is connected to the coupling capacitor Ccp and the second storage capacitor Cstb.

The first switching element Qa applies the data voltage from the data line DL to the first LC capacitor Clca according to the gate signal of the gate line GL.

The second switching element Qb applies the data voltage from the data line DL according to the gate signal of the same gate line GL as the first switching element Qa to the coupling capacitor Ccp, and the coupling capacitor Ccp converts the magnitude of the data voltage and transmits the converted data voltage to the second LC capacitor Clcb.

The common voltage Vcom is applied to the first and second storage capacitors Csta and Cstb.

If the capacitors Clca, Csta, Clcb, Clstb, and Ccp and their respective capacitances are expressed by the same reference indicia, the voltage Va charged at the first LC capacitor Clca and the voltage Vb charged at the second LC capacitor Clcb have the following relationship.

Vb=Va×[Ccp/(Ccp+Clcb)]

Since the value of Ccp/(Ccp+Clcb) is smaller than 1, the voltage Vb charged at the second LC capacitor Clcb is always smaller than the voltage Va charged at the first LC capacitor Clca.

The relationship is equally applied even if a voltage applied to the storage capacitor Csta is not the common voltage Vcom.

In view of the relationship between the voltages Vb and Va, the appropriate ratio of the voltage Va of the first LC capacitor Clca and the voltage Vb of the second LC capacitor Clcb can be obtained by controlling the capacitance of the coupling capacitor Ccp.

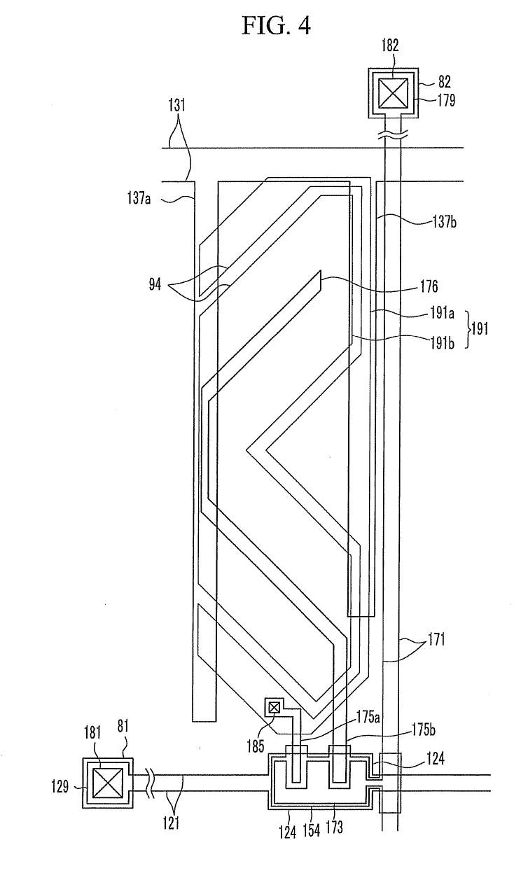

Now, the structure of the LC panel assembly shown in FIGS. 1 to 3 according to an exemplary embodiment will be described with reference to FIG. 4 to FIG. 8.

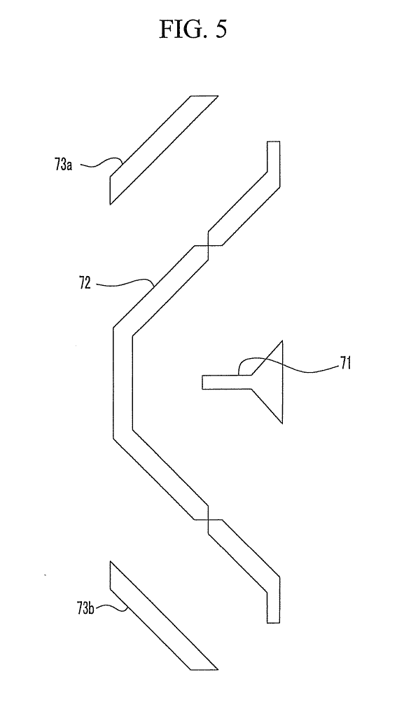

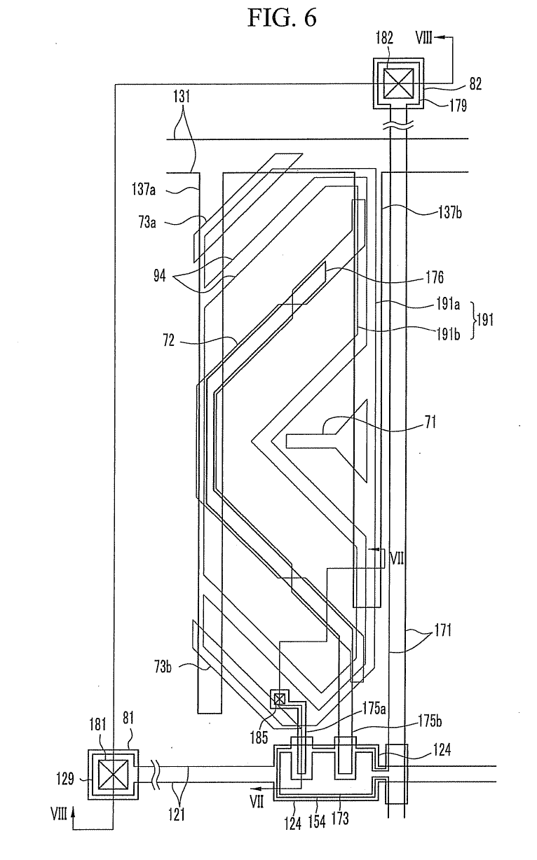

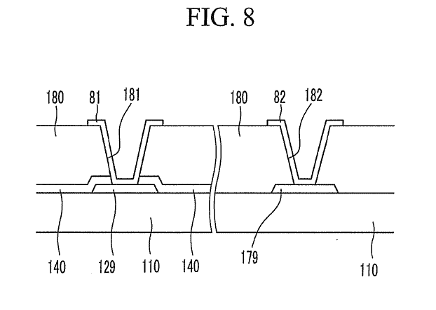

FIG. 4 is a layout view of an exemplary lower panel for an exemplary LCD according to an exemplary embodiment of the present invention, FIG. 5 is a layout view of an exemplary upper panel for an exemplary LCD according to an exemplary embodiment of the present invention, FIG. 6 is a layout view of an exemplary LC panel assembly including the exemplary lower panel shown in FIG. 4 and the exemplary upper panel shown in FIG. 5, and FIG. 7 and FIG. 8 are cross-sectional views of the exemplary LC panel assembly shown in FIG. 6 taken along lines VII-VII and VIII-VIII, respectively.

Referring to FIG. 4 to FIG. 8, an LCD according to an exemplary embodiment of the present invention includes a lower panel 100 and an upper panel 200 opposing the lower panel 100, and an LC layer 3 interposed between the two panels 100 and 200.

First, the lower panel 100 will be described in detail with reference to FIG. 4, FIG. 6, FIG. 7, and FIG. 8.

A plurality of gate conductors including a plurality of gate lines 121 and a plurality of storage electrode lines 131 are formed on an insulating substrate 110, which is preferably made of transparent glass or plastic.

The gate lines 121, which are separated from each other, extend substantially in a transverse direction, the first direction, and transmit gate signals.

Each gate line 121 includes a plurality of gate electrodes 124 protruding upward, such as in the second direction, and an end portion 129 having a large area for connection with another layer or an external driving circuit.

The storage electrode lines 131 extend substantially in a transverse direction, the first direction, and parallel to the gate lines 121, and are supplied with a predetermined voltage.

Each storage electrode line 131 is disposed between two neighboring gate lines 121.

The storage electrode lines 131 include a plurality of storage electrodes 137a and 137b that are protruded upward and downward, such as in the second direction.

While a particular arrangement of the storage lines 131 and storage electrodes 137a and 137b is shown and described, the shapes of the storage electrode lines 131 may be variously changed.

A gate insulating layer 140 is formed on the gate lines 121 and the storage electrode lines 131, and may be further formed on exposed portions of the insulating substrate 110.

A plurality of semiconductor islands 154 are formed on the gate insulating layer 140. The semiconductor islands 154 are disposed on the gate electrodes 124.

A plurality of ohmic contact islands 163 and 165 are formed on the semiconductor islands 154. The ohmic contact islands 163b and 165b are disposed in pairs on the semiconductor islands 154.

A plurality of data conductors including a plurality of data lines 171, and a plurality of pairs of first and second drain electrodes 175a and 175b, are formed on the ohmic contact islands 163 and 165, and on the gate insulating layer 140. The data lines 171 extending substantially in the longitudinal direction, the second direction, intersect the gate lines 121 and the storage electrode lines 131 and transmit data signals.

Each of the data lines 171 includes a plurality of source electrodes 173 branched out toward the gate electrodes 124 and an end portion 179 having an extended area for connection with another layer or an external driving circuit.

The first and second drain electrodes 175a and 175b are separated from the data lines 171, and the drain electrodes 175a and 175b oppose the source electrodes 173 with respect to the gate electrodes 124, respectively.

Each of the first and second drain electrodes 175a and 175b includes a stick-shaped first end portion, which is partially surrounded by the curved source electrode 173.

The second end portion of the second drain electrode 175b substantially extends parallel to the data line 171, then angles away from the data line 171, then extends parallel to the data line 171, and then angles toward the data line 171 again. Hereafter, this second end portion of the second drain electrode 175b is referred to as a coupling electrode 176.

A gate electrode 124, a source electrode 173, and a first drain electrode 175a along with the semiconductor 154 form the first TFT Qa having a channel formed in the semiconductor 154 disposed between the source electrode 173 and the first drain electrode 175a.

Also, a gate electrode 124, a source electrode 173, and the second drain electrode 175b along with the semiconductor 154 form a second TFT Qb having a channel formed in the semiconductor 154 disposed between the source electrode 173 and the second drain electrode 175b.

The ohmic contacts 163 and 165 are interposed only between the underlying semiconductors 154 and the overlying data conductors 171, 175a and 175b thereon, and reduce the contact resistance therebetween.

The semiconductors 154 include portions that are not fully covered with the data conductor 171 and 175, and thus are exposed, for example between the source electrodes 173 and the first and second drain electrodes 175a and 175b.

A passivation layer 180 is formed on the data conductors 171 and 175, and on the exposed semiconductors 154. The passivation layer 180 is further formed on exposed portions of the gate insulating layer 140. The passivation layer 180 may be formed using an inorganic insulator, an organic insulator, or the like, and may have a flat surface. Alternatively, the passivation layer 180 may have a dual film structure of a lower inorganic film and an upper organic film so that it protects the exposed semiconductors 154 while maintaining the excellent insulating characteristic of the organic film.

The passivation layer 180 has a plurality of contact holes 182 and 185, respectively exposing the end portions 179 of the data lines 171 and the first drain electrodes 175a.

The passivation layer 180 and the gate insulating layer 140 have a plurality of contact holes 181 respectively exposing the end portions 129 of the gate lines 121.

A plurality of pixel electrodes 191, a plurality of light shielding electrodes (not shown), and a plurality of contact assistants 81 and 82 are formed on the passivation layer 180.

Each pixel electrode 191 includes the first and second sub-pixel electrodes 191a and 191b. A pair of a first and a second sub-pixel electrode 191a and 191b forming a pixel electrode 191 engage with each other with a gap 94 disposed therebetween, and the first sub-pixel electrode 191a is interposed within the second sub-pixel electrode 191b.

The first sub-pixel electrode 191a is connected to the first drain electrode 175a through the contact hole 185.

The second sub-pixel electrode 191b overlaps the coupling electrode 176 for forming the coupling capacitor Ccp.

The first and second sub-pixel electrodes 191a and 191b and the common electrode 270 of the upper panel 200 along with the LC layer 3 therebetween form first and second LC capacitors Clca and Clcb to store the applied voltages even after the TFTs Qa and Qb are turned off.

The first and second sub-pixel electrodes 191a and 191b overlap the storage electrodes 137a and 137b to form first and second storage capacitors Csta and Cstb, which are connected in parallel with the LC capacitors Clca and Clcb, respectively, to enhance the voltage storing capacity thereof.

The contact assistants 81 and 82 are respectively connected to the end portions 129, 179 of the gate lines 121 and the data lines 171 through the contact holes 181 and 182. The contact assistants 81 and 82 have a function of aiding the adhesion of the exposed end portions 129 and 179 of the gate lines 121 and the data lines 171 to external apparatuses, and of protecting the end portions 129, 179.

Next, the common electrode panel 200 will be described with reference to FIG. 5, FIG. 6, and FIG. 7.

A light blocking member 220 is formed on an insulating substrate 210 that is preferably made of transparent glass or plastic. The light blocking member 220 may also be called a black matrix, and it prevents light leakage.

A plurality of color filters 230 are also formed on the substrate 210. The color filters 230 are disposed substantially in the areas enclosed by the light blocking member 220. The color filters 230 may slightly overlap the light blocking member 220 at a periphery thereof. Each of the color filters 230 may represent one of the set of colors, such as primary colors, and such as red, green, and blue.

An overcoat 250 is formed on the color filter 230 and the light blocking member 220. The overcoat 250 provides a flat surface.

A common electrode 270 is formed on the overcoat 250. The common electrode 270 is preferably made of a transparent conductive material such as indium tin oxide (“ITO”) and indium zinc oxide (“IZO”), and includes a plurality of sets of cutouts 71, 72, 73a, and 73b.

The number of cutouts 71, 72, 73a, and 73b may vary depending on design factors, and the light blocking member 220 may overlap the cutouts 71, 72, 73a, and 73b to prevent light leakage at the circumference or periphery of the cutouts 71, 72, 73a, and 73b.

Alignment layers 11 and 21 are coated on inner surfaces of the panels 100 and 200, and they may be homeotropic.

Polarizers 12 and 22 are provided on outer surfaces of the panels 100 and 200, their polarization axes may be perpendicular to each other, and one of the polarization axes is preferably parallel to the gate lines 121. In a reflective LCD, one of the two polarizers 12 and 22 may be omitted.

In the present exemplary embodiment, the LCD may further include a phase retardation film (not shown) for compensating a delay of the LC layer 3, and may further include a backlight unit (not shown) for providing light to the upper and lower panels 100 and 200 and the LC layer 3.

The LC layer 3 has negative dielectric anisotropy, and LC molecules of the LC layer 3 are aligned such that their longer axes are substantially perpendicular to the surfaces of the two display panels 100 and 200 in a state in which no electric field is applied.

Accordingly, incident light is blocked, rather than passing through the crossed polarizers 12 and 22.

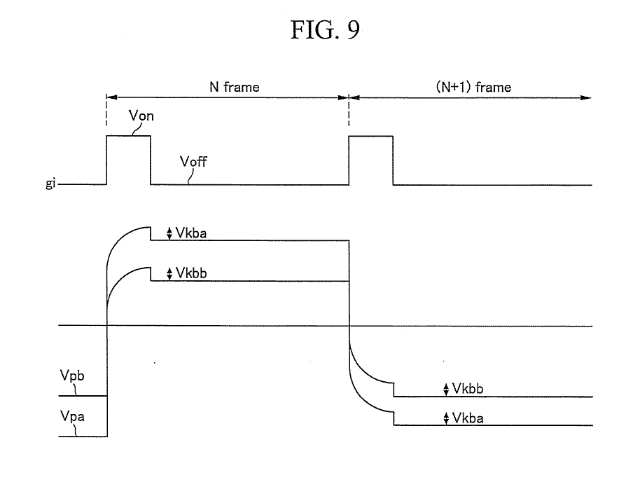

Now, the operation of the LCD according to an exemplary embodiment of the present invention will be described in detail with the reference to FIG. 9 as well as FIG. 1.

FIG. 9 is a waveform showing a pixel electrode voltage of an exemplary LCD according to an exemplary embodiment of the present invention.

Firstly, referring again to FIG. 1, the signal controller 600 receives input image signals R, G, and B and input control signals for controlling display thereof from an external graphics controller (not shown).

The input image signals R, G, and B include luminance information on each pixel PX. The luminance has a predetermined number of gray levels, for example 1024(=2¹⁰), 256(=2⁸), or 64(=2⁶) gray levels.

The input control signals may be, for example, a vertical synchronization signal Vsync, a horizontal synchronization signal Hsync, a main clock signal MCLK, a data enable signal DE, and so on.

The signal controller 600 processes the input image signals R, G, and B based on the input control signals according to the operation conditions of the LC panel assembly 300 and the data driver 500, and generates a gate control signal CONT1 and a data control signal CONT2. Then, the signal controller 600 transmits the gate control signal CONT1 to the gate driver 400, and transmits the data control signal CONT2 and processed image signals DAT to the data driver 500.

The processed image signals, that is, the output image signal DAT is a digital signal, and it has a predetermined number of values (or gray levels).

The scanning control signal CONT1 includes a scanning start signal STV that instructs to start scanning, and at least one clock signal that controls an output cycle of a gate-on voltage Von. The scanning control signal CONT1 may further include an output enable signal OE that defines the duration of the gate-on voltage Von.

The image data control signal CONT2 includes a horizontal synchronization start signal STH that informs the start of transmission of digital image signals DAT to sub-pixels of one row, a load signal LOAD that instructs to apply a data signal to the LC panel assembly 300, and a data clock signal HCLK. The data control signal CONT2 may further include an inversion signal RVS for reversing the polarity of the voltages of the data signals with respect to the common voltage Vcom (hereinafter, “the polarity of the voltages of the data signals with respect to the common voltage” is abbreviated to “the polarity of the data signals”).

In response to the data control signals CONT2 from the signal controller 600, the data driver 500 receives digital image signals DAT for a row of sub-pixels from the signal controller 600, converts the digital image signals DAT into analog data signals by selecting gray voltages from the gray voltage generator 800 corresponding to the respective digital image signals DAT, and applies the analog data signals DAT to the data lines D1 to Dm.

The gate driver 400 applies the gate-on voltage Von to the gate lines G1-Gn in response to the gate control signals CONT1 from the signal controller 600, thereby turning on the switching elements connected thereto.

The data voltages applied to the data lines D1-Dm are supplied to the sub-pixels PXa and PXb through the turned-on switching elements Qa and Qb.

In this way, if the potential difference is generated in both ends of the first or second liquid crystal capacitors Clca and Clcb, a primary electric field that is almost perpendicular to a surface of the display panels 100 and 200 is generated in the LC layer 3.

Hereinafter, a pixel electrode 191 and a common electrode 270 are referred to as “field generating electrodes.” LC molecules of the liquid crystal layer 3 are inclined so that a long axis thereof is perpendicular to a direction of an electric field in response to the electric field, and the degree of change of polarization of light incident to the LC layer 3 depends on the change of an inclination degree of the LC molecules.

The change of the polarization is represented with the change of transmittance by a polarizer, such as one or both of polarizers 12 and 22 as shown in FIG. 7, whereby an LCD displays an image representing the image signal DAT.

Here, referring to FIG. 9, if the gate signal gᵢ applied from the gate driver 400 to the i-th gate line is converted into the gate-on voltage Von, the first and second TFTs Qa and Qb are turned on such that the first LC capacitor Clca, the second storage capacitor Csta, the second storage capacitor Cstb, and the coupling capacitor Ccp in the pixel row connected to the i-th gate line are charged.

Then, as above-described, the second LC capacitor Clcb is charged with a value that is less than that of the first LC capacitor Clca according to the charged amount according to the first LC capacitor Clca and the coupling capacitor Ccp.

That is, the first and second sub-pixel electrode voltages Vpa and Vpb are increased to desired levels, wherein the second sub-pixel electrode voltage Vpb is less than the first sub-pixel electrode voltage Vpa.

Then, after the gate signal gᵢ is changed to the gate-off voltage Voff, the first and second LC capacitors Clca and Clcb maintain, or at least substantially maintain, the charged voltage, and the first and second storage capacitors Csta and Cstb respectively enhance the voltage storing of the first and second LC capacitors Clca and Clcb.

Here, when the gate signal gᵢ is changed from the gate-on voltage Von to the gate-off voltage Voff, the first and second sub-pixel electrode voltages Vpa and Vpb are respectively decreased by predetermined amounts due to the parasitic capacitances generated between the gate lines 121 and the pixel electrodes 191, etc.

The decreased amounts of the first and second pixel electrode voltages Vpa and Vpb are respectively referred to as the first kickback voltage Vkba and the second kickback voltage Vkbb.

The first and second kickback voltages Vkba and Vkbb are respectively defined by the following equations:

Vkba={Cgpa/(Cgpa+Csta+Clca)}×ΔVg

Vkbb={Cgpb/(Cgpb+Cstb+Clcb)}×ΔVg

Here, Cgpa and Cgpb are parasitic capacitances respectively generated between the first and second sub-pixel electrodes 191a, 191b and the gate lines 121, and ΔVg is the difference between the gate-on voltage Von and the gate-off voltage Voff.

If the first kickback voltage Vkba and the second kickback voltage Vkbb are changed, the first and second sub-pixel electrode voltages Vpa and Vpb with respect to the common voltage Vcom are changed.

Generally, since the value of the common voltage Vcom is determined by reference to the first sub-pixel electrode voltage Vpa, the second sub-pixel electrode voltage Vpb with respect to the common voltage Vcom may be different from the desired level such that the image-retension of the conventional LCD may be observed.

Accordingly, in the LCD according to an exemplary embodiment of the present invention, the first and second sub-pixel electrodes 191a and 191b are respectively connected to the first and second TFTs Qa and Qb such that the first and second kickback voltages Vkba and Vkbb are equalized such that the first and second sub-pixel electrodes 191a and 191b are influenced by the kickback voltage, equally.

Also, the first and second kickback voltages Vkba and Vkbb are controlled to be equal to each other by controlling the parasitic capacitances Cgpa and Cgpb, the LC capacitors Clca and Clcb, and the storage capacitors Csta and Cstb of the first and second sub-pixels PXa and PXb.

Each of the parasitic capacitances Cgpa and Cgpb may be changed by controlling the overlapping areas and the distances between the gate lines 121, and the first and second sub-pixel electrodes 191a and 191b.

Accordingly, first and second sub-pixel electrode voltages Vpa and Vpb that correctly correspond to the luminance of the desired image with respect to the common voltage Vcom may be obtained, thereby preventing the generation of image-retensions.

On the other hand, the tilt angles of the LC molecules in the LC layer 3 are changed according to the strength of an electric field. Therefore, since the voltages of the two LC capacitors Clca and Clcb are different from each other, the tilt angles of the LC molecules in the two sub-pixels PXa and PXb may be different from each other and thus the luminance of the two sub-pixels PXa and PXb may be different from each other.

Therefore, when the voltages of the first and second LC capacitors Clca and Clcb are appropriately adjusted, it is possible to make an image viewed from the side be as similar as possible to an image viewed from the front, that is, to make the gamma curve of the side view be as similar as possible to the gamma curve of the front view. In this way, it is possible to improve the side visibility.

A ratio of the voltage Va of the first LC capacitor Clca to the voltage Vb of the second LC capacitor Clcb can be obtained by adjusting the capacitance of the coupling capacitor Ccp, and the capacitance of the coupling capacitor Ccp may be changed by adjusting the overlapping area and the distance between the second sub-pixel electrode 191b and the coupling electrode 176.

In an alternative exemplary embodiment, the voltage Vb charged in the second LC capacitor Clcb may be larger than the voltage Va of the first LC capacitor Clca. This can be realized by precharging the second LC capacitor Clcb with a predetermined voltage such as the common voltage Vcom.

The tilt direction of the LC molecules in the LC layer 3 is determined by a horizontal component generated by the cutouts 71-73b of the field generating electrodes 191 and 270 and the oblique edges of the pixel electrodes 191 distorting the electric field, and this horizontal component is substantially perpendicular to the edges of the cutouts 71-73b and the oblique edges of the pixel electrodes 191.

Referring to FIG. 4, a set of the cutouts 71-73b divides a pixel electrode 191 into a plurality of sub-areas, and each sub-area has two major edges.

Since the LC molecules within each sub-area tilt perpendicular to the major edges, the azimuthal distribution of the tilt directions are almost localized to four directions.

Accordingly, the tilt direction of the LC molecules within the LC layer 3 may be diverse thereby increasing the reference viewing angle of the LCD. In addition, when the areas that can transmit light for the above-described four tilt directions are the same, the visibility becomes better for various viewing directions.

Since the opaque members are symmetrically arranged as described above, the adjustment of the transmissive areas is easy.

The shapes and the arrangements of the cutouts 71-73b for determining the tilt directions of the LC molecules may be modified, and at least one of the cutouts 71-73b can be substituted with protrusions (not shown) or depressions (not shown).

The protrusions are preferably made of an organic or inorganic material and disposed on or under the field-generating electrodes 191 or 270.

By repeating the above procedure by a unit of the horizontal period (which is denoted by “1H” and is equal to one period of the horizontal synchronization signal Hsync and the data enable signal DE), all gate lines G1-Gn are sequentially supplied with the gate-on voltage Von, thereby applying the data signals to all pixels to display an image of one frame.

When the next frame starts after finishing one frame, the inversion control signal RVS applied to the data driver 500 is controlled such that the polarity of the data signals is reversed (which is referred to as “frame inversion”). The inversion control signal RVS may also be controlled such that the polarity of the data signals flowing in a data line in one frame are reversed (for example line inversion and dot inversion) according to the characteristics of the inversion control signal RVS, or the polarity of the data signals applied to a row of pixels are reversed (for example column inversion and dot inversion).

According to the present invention, side visibility may be improved and an image-retension may be removed to thereby increase display quality.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a gate line;
a data line intersecting the gate line; and
a pixel including a first sub-pixel and a second sub-pixel connected to the gate line and the data line;
wherein the first sub-pixel comprises a first liquid crystal capacitor comprising a first sub-pixel electrode, and a first thin film transistor,
the second sub-pixel comprises a second liquid crystal capacitor comprising a second sub-pixel electrode, a coupling capacitor and a second thin film transistor,
the first and second thin film transistors respectively include a gate electrode, a source electrode, and a drain electrode, the gate electrodes of the first and second thin film transistors are connected to the gate line, and the source electrodes of the first and second thin film transistors are connected to the data line, and
the coupling capacitor comprises the sub-pixel electrode and a coupling electrode connected to the drain electrode of the second thin film transistor as two terminals.

2. The liquid crystal display of claim 1, wherein
when the first and second thin film transistors are turned off, a voltage of the first sub-pixel electrode and a voltage of the second sub-pixel electrode drop by a same amount.

3. The liquid crystal display of claim 2, wherein
the gate electrodes of the first and second thin film transistors are connected to each other.

4. The liquid crystal display of claim 3, wherein
the source electrodes of the first and second thin film transistors are connected to each other.

5. The liquid crystal display of claim 4, wherein the gate electrodes protrude from the gate line and the source electrodes protrude from the data line, and a shared semiconductor island is formed between the gate electrodes and the source electrodes.

6. The liquid crystal display of claim 1, wherein
the first sub-pixel electrode is connected to the drain electrode of the first thin film transistor.

7. The liquid crystal display of claim 6, wherein
the second sub-pixel electrode is coupled with the drain electrode of the second thin film transistor.

8. The liquid crystal display of claim 7, wherein
a voltage of the first sub-pixel electrode is different from a voltage of the second sub-pixel electrode.

9. The liquid crystal display of claim 8, wherein
the voltage of the first sub-pixel electrode is higher than the voltage of the second sub-pixel electrode.

10. The liquid crystal display of claim 8, wherein
an area of the first sub-pixel electrode is different from an area of the second sub-pixel electrode.

11. The liquid crystal display of claim 1, wherein
the first sub-pixel further comprises a first storage capacitor and the second sub-pixel further comprises a second storage capacitor.

12. A liquid crystal display comprising:
a pixel electrode including a first sub-pixel electrode and a second sub-pixel electrode separated from the first sub-pixel electrode;
a first thin film transistor connected to the first sub-pixel electrode;
a second thin film transistor connected to a coupling electrode overlapped by the
second sub-pixel electrodes; and
a storage electrode overlapped by the first and second sub-pixel electrodes;
wherein the second thin film transistor includes a drain electrode and
the coupling electrode is connected to the drain electrode of the second thin film transistor.

13. The liquid crystal display of claim 12, further comprising
a first signal line connected to the first and second thin film transistors, and
a second signal line connected to the first and second thin film transistors and intersecting the first signal line.

14. A method of reducing generation of an image-retension in a liquid crystal display, the liquid crystal display including a pixel comprising a first sub-pixel and a second sub-pixel, the method comprising:
applying first and second sub-pixel electrode voltages to the first and second sub-pixels via a same data line, the second sub-pixel electrode voltage being less than the first sub-pixel electrode voltage;
applying a gate off voltage to first and second liquid crystal capacitors of the first and second sub pixels via a same gate line; and,
substantially equalizing an amount of first and second kickback voltages of the first and second sub-pixels.

15. The method of claim 14, wherein substantially equalizing first and second kickback voltages of the first and second sub-pixels includes controlling parasitic capacitances, liquid crystal capacitors, and storage capacitors of the first and second sub-pixels.

16. The method of claim 14, wherein
the first sub-pixel comprises the first liquid crystal capacitor comprising a first sub-pixel electrode and a first thin film transistor,
the second sub-pixel comprises the second liquid crystal capacitor comprising a second sub-pixel electrode, a coupling capacitor and a second thin film transistor,
the first and second thin film transistors respectively include a gate electrode, a source electrode, and a drain electrode, the gate electrodes of the first and second thin film transistors are connected to the gate line, and the source electrodes of the first and second thin film transistors are connected to the data line, and
the coupling capacitor comprises the sub-pixel electrode and a coupling electrode connected to the drain electrode of the second thin film transistor as two terminals.

17. The method of claim 14, wherein
the first sub-pixel includes a first sub-pixel electrode and a first thin film transistor connected to the first sub-pixel electrode, and the second sub-pixel includes a second sub-pixel electrode separated from the first sub-pixel electrode and a second thin film transistor which comprises a drain electrode, and a coupling electrode is connected to the drain electrode and overlapped the second sub-pixel electrode.
